(19) United States
(12) Patent Application Publication
(10) Pub. No.: US 2011/0054817 A1
(43) Pub. Date: Mar. 3, 2011

(54) Battery Run-Time Prediction System

(76) Inventor: Jeff Burgett, Alpharetta, GA (US)

(21) Appl. No.: 12/874,198

(22) Filed: Sep. 1, 2010

Related U.S. Application Data
(60) Provisional application No. 61/239,093, filed on Sep. 2, 2009.

(51) Int. Cl. G06F 19/00

(52) U.S. Cl. 702/63

(57) ABSTRACT

Embodiments of the present disclosure include a computer implemented method and system for sampling battery runtime-related information from the batteries to provide an ongoing estimate of the remaining runtime left at a remote location based, at least in part, on a combination of computing techniques and statistical and mathematical models.

### CLAIM OF PRIORITY

This application claims the benefit of priority from U.S. Provisional Patent Application Ser. No. 61/239,093 filed on Sep. 2, 2009 and entitled “Battery Run-Time Prediction”, which is fully incorporated herein by reference for all purposes.

### FIELD

Certain embodiments of the present disclosure generally relate to a method and apparatus for remote power monitoring and, more particularly, an automated system for determining the remaining battery backup time at a given location.

### BACKGROUND

The lead-acid battery has been used widely as a secondary battery for 140 years, since its invention by Planté in 1859. Development of the battery has been pursued vigorously all over the world. The valve-regulated lead-acid (VRLA) battery is a more recent variant that generally uses an absorptive glass mat (AGM) separator. The market for VRLA batteries has been growing for telecommunications and other operationally critical organizations.

The need to understand how much backup power from a stored power device is remaining has manifested itself since the time they came into use. Backup batteries and generators have been in place since the 1800's. A battery run-time prediction (RTP) system allows operations personnel to know how much battery backup time is remaining at a given location such as a wireless communication cell site, cable communication headend, bank, department store, data center, etc. This knowledge allows the operations staff to efficiently, and effectively deploy additional backup power facilities such as a mobile generator to the effected location in order to keep the site online.

### SUMMARY

Certain embodiments provide a method for sampling battery runtime-related information from one or more battery strings to provide an ongoing estimate of a remaining runtime left at a remote location. The method generally includes receiving input data for each battery string of the one or more battery strings, evaluating the input data and synthesizing one or more pieces of supplemental data, filtering the input data and the one or more pieces of supplemental data, storing the previously filtered data, generating a discharge model based on the stored filtered data, determining a remaining runtime for the one or more battery strings based on the discharge model, and communicating a return code for the one or more battery strings and an entire site based on the corresponding remaining runtime and average string voltage.

Certain embodiments provide an apparatus for sampling battery runtime-related information from one or more battery strings to provide an ongoing estimate of a remaining runtime left at a remote location. The apparatus generally includes means for receiving input data for each battery string of the one or more battery strings, means for evaluating the input data and synthesizing one or more pieces of supplemental data, means for filtering the input data and the one or more pieces of supplemental data, means for storing the previously filtered data, means for generating a discharge model based on the stored filtered data, means for determining a remaining runtime for the one or more battery strings based on the discharge model, and means for communicating a return code for the one or more battery strings and an entire site based on the corresponding remaining runtime and average string voltage.

Certain embodiments provide a computer-program product for sampling battery runtime-related information from one or more battery strings to provide an ongoing estimate of a remaining runtime left at a remote location in a suitable computer, the computer-program product comprising a computer readable medium having instructions thereon. The instructions generally include code for receiving input data for each battery string of the one or more battery strings, code for evaluating the input data and synthesizing one or more pieces of supplemental data, code for filtering the input data and the one or more pieces of supplemental data, code for storing the previously filtered data, code for generating a discharge model based on the stored filtered data, code for determining a remaining runtime for the one or more battery strings based on the discharge model, and code for communicating a return code for the one or more battery strings and an entire site based on the corresponding remaining runtime and average string voltage.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 is a block diagram illustrating an exemplary system in which embodiments of the present disclosure may be deployed.

FIG. 2 illustrates a communication mechanism which may be implemented in accordance with embodiments of the present disclosure.

FIG. 3 illustrates a typical flow chart in accordance with embodiments of the present disclosure.

FIG. 4 illustrates a set of discharge curves from production sites, in accordance with embodiments of the present disclosure.

FIG. 5 illustrates possible display information provided in conjunction with return codes, in accordance with embodiments of the disclosure.

### DETAILED DESCRIPTION

As previously mentioned, a battery run-time prediction (RTP) system allows operations personnel to know how much battery backup time is remaining at a given location such as a wireless communication cell site, cable communication headend, bank, department store, data center, etc. The battery RTP system may receive a battery string voltage from one or more battery strings at a site approximately once per minute. The results provided by certain embodiments may not be significantly affected if the time varies by a few minutes or if it is variable due to network latency. If available, the battery RTP system can make use of individual battery voltage information as well. Other parameters, such as temperature, load current, electrochemical characteristics of each battery, and battery environmental and discharge history are reflected indirectly in the behavior of the battery and battery string voltage over time. The interrelationships between battery strings as related to runtime may be factored into the result to provide an overall site level estimate.

The RTP system may be implemented in a hardware/firmware embedded environment where it will determine the runtime for a single location or it can run on a customer's portal or application server where it can processes thousands of simultaneous standby events from multiple locations.

Among other things, the present disclosure presents solutions for providing site-level battery runtime estimates independent of the number of strings, number of batteries in each string, make or model of the battery, or battery history. Embodiments of the present disclosure may automatically adjust runtime prediction as battery conditions change, such as temperature or load, by utilizing a combination of integrated techniques (e.g., expert system technology, statistical models, data filtering and smoothing, and mathematical models). Furthermore, embodiments may provide consistent tracking of the estimated remaining runtime without repeated and frequent changes to the remaining runtime values. Moreover, certain embodiments may be implemented without complex or costly hardware for monitoring battery temperature, measuring current, or taking high resolution voltage measurements. In fact, the voltage granularity required for some embodiments is merely 1/10^{th} of a volt.

### An Examplary Battery Run-Time Prediction System

In the following, reference is made to embodiments of the present disclosure. However, it should be understood that the present disclosure is not limited to specific described embodiments. Instead, any combination of the following features and elements, whether related to different embodiments or not, is contemplated to implement and practice the present disclosure. Furthermore, in various embodiments the disclosure provides numerous advantages over the prior art. However, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the present disclosure” shall not be construed as a generalization of any inventive subject matter disclosed herein and shall not be considered to be an element or limitation of the appended claims except where explicitly recited in a claim(s).

One embodiment of the present disclosure is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; and (ii) writable storage media (e.g., floppy disks within a diskette drive, a hard-disk drive or random-access memory) on which alterable information is stored. Such computer-readable storage media, when carrying computer-readable instructions that direct the functions of the present disclosure, are embodiments of the present disclosure. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present disclosure, are embodiments of the present disclosure. Broadly, computer-readable storage media and communications media may be referred to herein as computer-readable media.

In general, the routines executed to implement the embodiments of the disclosure, may be part of an operating system or a specific application, component, program, module, object, or sequence of instructions. The computer program of the present disclosure is typically comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the disclosure. However, it should be appreciated that any particular program nomenclature that follows is used merely for convenience, and thus embodiments should not be limited to use solely in any specific application identified and/or implied by such nomenclature.

A client system may generally include a central processing unit (CPU) connected by a bus to memory and storage. Each client system is typically running an operating system configured to manage interaction between the computer hardware and the higher-level software applications running on the client system. The server system may include hardware components similar to those used by the client system (e.g., a CPU, a memory, and a storage device, coupled by a bus). However, such a network environment is merely an example of one computing environment. Embodiments of the present disclosure may be implemented using other environments, regardless of whether the computer systems are complex multi-user computing systems, such as a cluster of individual computers connected by a high-speed network, single-user workstations, or network appliances lacking non-volatile storage. Further, embodiments of the disclosure may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

While embodiments of the disclosure may be susceptible to various modifications and alternative forms, specific embodiments thereof are shown by way of example in the drawings and will herein be described in detail. The drawings may not be to scale. It should be understood, however, that the drawings and detailed description thereto are not intended to limit embodiments to the particular form disclosed, but to the contrary, the intention is to cover all modifications, equivalents, and alternatives falling within the spirit and scope of the present disclosure as defined by the appended claims.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments of the disclosure.

It is to be understood that the forms of the disclosure shown and described herein are to be taken as examples of embodiments. Elements and materials may be substituted for those illustrated and described herein, parts and processes may be reversed, and certain features of the disclosure may be utilized independently, all as would be apparent to one skilled in the art after having the benefit of this disclosure. Changes may be made in the elements described herein without departing from the spirit and scope of the disclosure as described in the following claims.

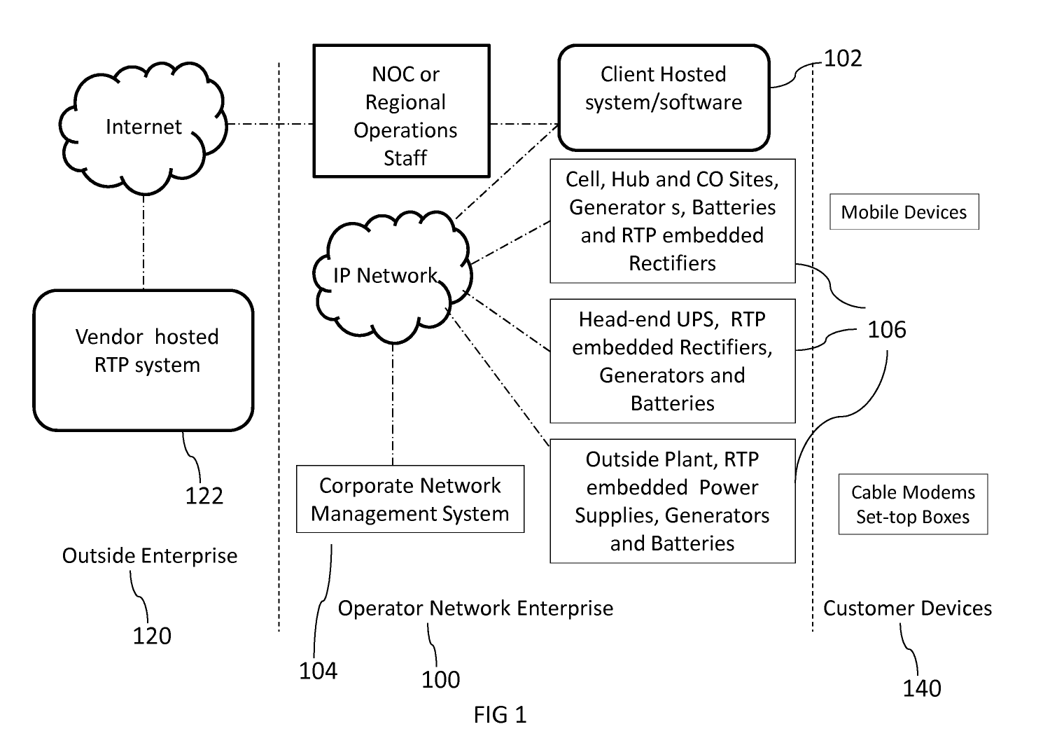

FIG. 1 is a block diagram illustrating an exemplary system in which embodiments of the present disclosure may be deployed. The exemplary system contains blocks representing hardware and software which may be part of an operator network or enterprise 100, an outside enterprise 120, or a set of customer devices 140.

It is expected that ideal embodiments of the present disclosure may be implemented in hardware, software, or firmware which is part of an operator's network or enterprise 100. For example, in some instances certain aspects of the disclosure may be implemented on one or more customer portals or application servers 102 located at a network operations center (NOC) or with regional operations staff. These aspects of the disclosure may include applications configured to display results communicated from remote locations such as a wireless communication cell site, cable communication headend, bank, department store, or data center. The aspects of the disclosure implemented on one or more networked computers 102 may also include hardware or applications configured to calculate the remaining battery runtimes for one or more remotely located battery strings.

In other instances, aspects of the disclosure may be implemented as part of a corporate network management system 104 in addition to or as an alternative to the one or more customer portals or application servers 102. These aspects of the disclosure may include applications configured to display results communicated from remote locations such as a wireless communication cell site, cable communication headend, bank, department store, or data center. The aspects of the disclosure may be implemented as part of a corporate network management system 104 may also include hardware or applications configured to calculate the remaining battery runtimes for one or more remotely located battery strings.

Simultaneously, some aspects of the disclosure may be implemented in hardware, software, or firmware at remotely located wireless communication cell sites, cable communication headends, banks, department stores, or data centers 106. For example, aspects of the disclosure implemented at remote sites may be configured to communicate input data such as an average string voltage, elapsed outage time, individual battery voltages, or string cutoff voltages. However, aspects of the disclosure implemented at remote sites may also be configured to calculate the remaining runtime of one or more battery strings located at the remote site and communicate a return code for each battery string and an entire site based on the corresponding remaining runtime and average string voltage.

It is expected that ideal embodiments of the present disclosure may also be implemented in hardware, software, or firmware which is part of an outside enterprise 120. For example, in certain embodiments aspects of the disclosure may be implemented as software hosted on a third party server 122 (e.g., servers maintained by Seldon Systems). In such embodiments, aspects of the disclosure implemented at remote sites may be configured to communicate input data to the third party system or configured to calculate the remaining runtime of one or more battery strings located at the remote site and communicate a return code for each battery to the third party system.

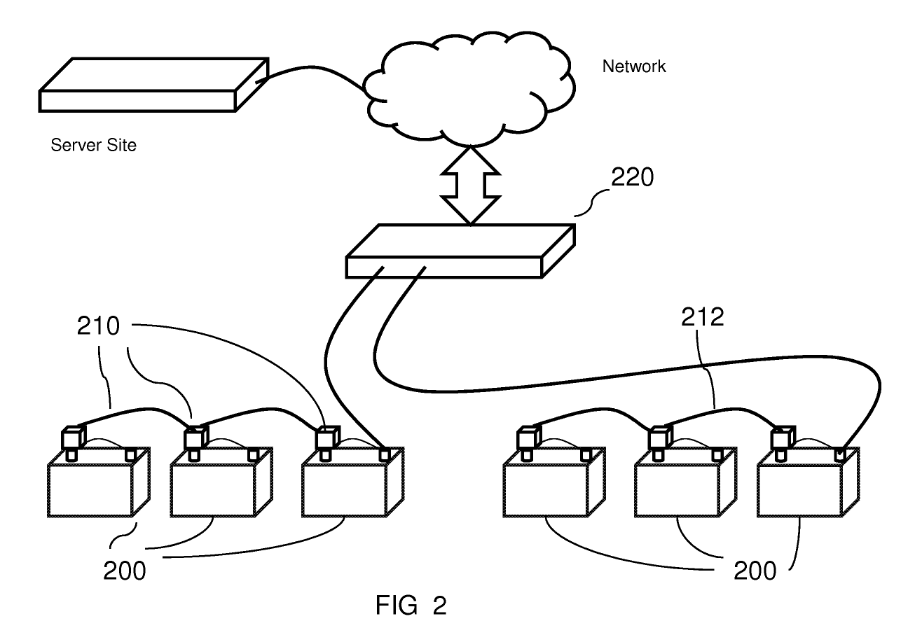

FIG. 2 further illustrates a communication mechanism which may be implemented in accordance with embodiments of the present disclosure. For example, in some embodiments aspects of the disclosure implemented at remote sites may be configured to communicate input data or return codes to a customer portal/application server 102 or a corporate network management system 104. In other embodiments aspects of the disclosure implemented at remote sites may be configured to communicate input data or return codes to a third party system. In both situations aspects of the disclosure implemented at remote sites must communicate with aspects of the disclosure implemented elsewhere.

The communication between aspects of the disclosure comprises two parts: communication of input data from one or more battery strings at the remote site and aspects of the disclosure implemented at said remote site and communication between aspects of the disclosure implemented at the remote site and aspects of the disclosure implemented elsewhere.

Communication of input data from one or more battery strings 200 at the remote site and aspects of the disclosure implemented at said remote site 220 involves one or more battery agent sensor units 210 determining a set of input data, at least one cable 212 communicating the input data along the battery string 200 (e.g., an RJ-11 “Daisy Chain”), and at least one cable from the battery string 200 to aspects of the disclosure implemented at said remote site (e.g., a master agent site controller 220). In certain embodiments the input data may include an average string voltage, an elapsed outage time (or time the batteries have been deployed), battery voltages for individual batteries within the battery string, or a string cutoff voltage. In some embodiments the master agent site controller 220 may facilitate the communication between 6 battery strings 200 and aspects of the disclosure implemented elsewhere.

After the input data has been communicated from the one or more battery strings 200 to aspects of the disclosure implemented at said remote site 220. The input data may be evaluated to determine a remaining runtime and a corresponding return code. Regardless of whether the input data is evaluated or merely passed through, the master agent site controller 220 subsequently communicates the appropriate information to aspects of the disclosure implemented elsewhere. This may be done over various communication cables utilizing a variety of communication protocols. For example, this communication may employ traditional IP protocols utilizing CAT-5 cables.

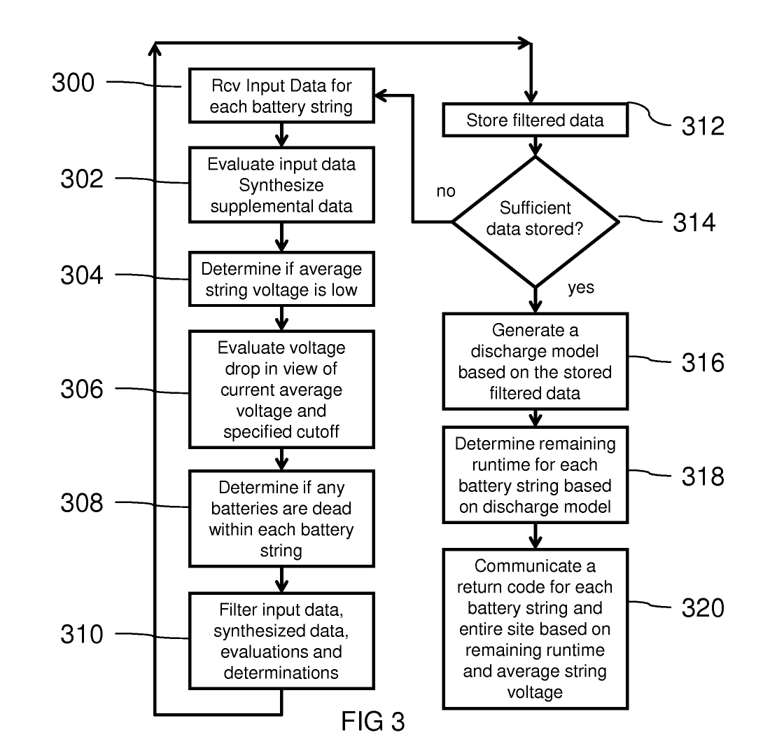

FIG. 3 illustrates typical operations in accordance with embodiments of the present disclosure. Operations begin at 300 where aspects of the present disclosure receive one or more pieces of input data for each battery string such as an average string voltage, an elapsed outage time, an individual battery voltage, or a string cutoff voltage. In order to have the broadest use, embodiments of the disclosure were designed to require a minimum amount of battery data with each data sample. For example, the RTP system merely requires a string voltage for each string of batteries and an elapsed outage time (or time the batteries have been deployed). If the data is coming into the RTP system in near real-time or the time or time/date stamp is provided with each piece of data, then the time from the beginning of the standby event may be calculated by aspects of the RTP system. In certain embodiments the RTP system may also receive a battery voltage for each individual battery, the number of batteries in each string, and a battery string cutoff voltage based on the number of batteries in the string. If, however, the number of batteries per string is too large to be determined from the string voltage (e.g. more than four 12-volt batteries), the RTP system may return an invalid or incomplete data message.

At 302, embodiments may then evaluate input data and synthesize supplemental data. For example, embodiments may calculate the number of battery strings at the remote location based on the number of string voltage data sets that are passed into the RTP system, the number of batteries per battery string, or a string cutoff voltage. After the RTP system has been initialized and supplemental data has been synthesized, the remaining runtime may be calculated for each individual battery string.

String-level remaining runtime calculations are the most complex part of the RTP system. Remaining runtime calculations utilize a combination of case-based processing derived from a set of statistical heuristics and mathematical models. The set of cases each apply a one or more tests on the input data to determine if the case is true. Sometimes a final string-level calculation may be returned based on the “truth” of a single case, while in other conditions, a combination of “true” cases are required. This could be implemented in a number of ways, e.g. rule-based expert system, case-based reasoning system, etc. The important point is that it is based on a set of cases that test the incoming data against a set of statistical heuristics derived from a large data set of field data.

For example, at 304, embodiments may determine if the average string voltage is low for each battery string. A first such case utilized in checking for low string voltages may include a first test. The first test may indicate a battery cutoff voltage (batteryCutoffThreshold) has been reached and the system has shut down, an outage is eminent due to a low string voltage, or an outage is not eminent and more analysis is needed to determine the remaining runtime. If the first test indicates the system has shut down, a variable representing Case 1 may be set to “true” and a remaining runtime of 0 may be returned.

However, if the first test indicates an outage is eminent due to the low string voltage and a low voltage point heuristic for less than 15 minutes (τ<15) (lowVoltagePoint15) is detected, a return code of xxx may be returned, where xxx is calculated as 10 times the string voltage. Though, if the first test indicates an outage is eminent due to the low string voltage, a low voltage point heuristic for 15 to 59 minutes or less (15<=τ<60) (lowVoltagePoint60) is detected, and the standby event commenced within the past 60 minutes, a return code of 1xxx may be returned. Nevertheless, if the first test indicates an outage is eminent due to the low string voltage, a medium voltage point heuristic for 15 to 59 minutes or less (15<=τ<60) (medVoltagePoint60) is detected, and the standby event occurred within the past 30 minutes, a return code of 1xxx may be returned.

Still, if the first test indicates an outage is not eminent and more analysis is required to determine remaining runtime, a code of −1 may be returned indicating that Test 1 failed and the variable representing Case 1 may be set to “false.”

As in the first case, the second case which may be utilized in checking for low string voltages may include a test to check for a low string voltage higher than that found in Case 1 and a voltage drop the rate of which is high. Like the first test, this second test may indicate an outage is eminent due the low string voltage and a rapid drop of the voltage.

If the second test indicates an outage is eminent, a variable representing Case 2 may be set to “true.” The normalized battery voltage is less than or equal to the low voltage with a high voltage drop heuristic (lowVoltageWithROC) and the voltage drop rate of change is greater than a high rate of change and a low voltage heuristic (highROCWithLowVoltage) for a duration in minutes as defined by a period of time that the low voltage (lowVoltageWindow) is detected, a return code of xxx may be returned. However, if the second test indicates an outage is not eminent and more analysis is required to determine the remaining runtime, a variable representing Case 2 may be set to “false” and a code of −1 may be returned.

As in the first and second cases, the third case which may be utilized in checking for low string voltages may include a test to check for a low string voltage higher than that found in Case 1 and a voltage drop the rate of which is moderately high. As in the second case, the third case may employ the second test which may indicate an outage is eminent due the low string voltage and a rapid drop of the voltage.

If the second test indicates an outage is eminent, a variable representing Case 3 may be set to “true.” However, if the normalized battery voltage is less than or equal to a low voltage with high voltage drop heuristic (lowVoltageWithROC), and the rate of change is greater than the high rate of change with low voltage heuristic (medROCWithLowVoltage) is detected for at least the previous 15 minutes, a return code of 1xxx may be returned. However, if the second test indicates an outage is not eminent and more analysis is required to determine the remaining runtime, a variable representing Case 3 may be set to “false” and a code of −1 may be returned.

At 306, embodiments of the present disclosure may evaluate the voltage drop in view of the current average voltage and a specified cutoff voltage. Case 4 checks the proportional voltage drop of the current average voltage from the initial voltage to the specified cutoff voltage by utilizing a third test. Test 3 may be used to indicate whether an outage is eminent due to a significant average battery voltage drop or whether an outage is not eminent and more analysis is required. If the average current battery voltage drops) by the (batteryVoltageDropRatio) from the initial normalized battery voltage to the battery cutoff voltage, a variable representing Case 4 may be set to “true” and a return code of 1xxx may be returned. The average current battery voltage may be determined by taking the average of a number, x, of the most recent voltage data points. In preferred embodiments x may be set to three. If an outage is not eminent and more analysis is required to determine remaining runtime, the variable representing Case 4 may be set to “false” and a code of −1 may be returned.

At 308, embodiments may determine if any batteries are dead within each battery string. Case 5 checks for one or more “dead” batteries within a string in order to compensate for the impact these batteries will have on the string by employing a fifth test. Test 5 may be used to indicate whether or not one or more “bad” batteries exist within a battery string. If one or more “bad” batteries are found in the battery string by determining the standard deviation (or percent difference for less than three batteries in a string) between voltages of each battery with other batteries in a string, a compensation factor may be applied to the final string-level runtime estimate and Case 5 may be set to “true”. However, if no “bad” batteries are found, a code of −1 may be returned and Case 5 may be set to “false.”

At 310, embodiments may filter the input data, the synthesized data, previous evaluations, and previous determinations and store the filtered data at 312. Cases 6 through 12 may be used to determine the estimated remaining runtime based on a set of calculations in Test 4. Test 4 is divided into two steps: data filtering and remaining runtime calculations.

In the first step, pairs of the string voltage and their corresponding timestamps may be used to generate a battery string discharge graph of string voltage versus time. One significant component of estimating battery runtime is predicting the path of this discharge graph. One approach taken by embodiments of the present disclosure is to filter a set of points that will best represent the discharge (i.e. the rate of voltage change during discharge). Three critical aspects of determining the rate of voltage change during discharge are the average voltage of the normalized battery string just after the start of the standby event, the average voltage of the normalized battery string of the most recent data points, and the minimum amount of time since the start of the standby event that is required to obtain a sufficient amount of data to create a useful discharge profile (i.e. minROCWindow).

At 314, embodiments of the disclosure may determine if a sufficient volume of filtered data is stored. If an insufficient volume of data is stored embodiments may return to 300 and continue receiving input data from each battery string for an additional period of time. However, if it is determined that sufficient filtered data has been stored, embodiments may proceed to 316 and generate a discharge model based on the filtered data which has been stored.

As time elapses from the start of the standby event, the initial average voltage is calculated based on the average of the highest voltages associated with an initialNumVoltagePoints during the first several minutes of the standby event as defined by an initialNumVoltagePointsWindow. This allows for compensation of the Coup de Fouet region of the discharge (i.e., the region at the beginning of a discharge in which a voltage drop occurs in a previously fully charged lead-acid battery) and any additional fluxuation in voltage that occurs immediately after the start of the standby event.

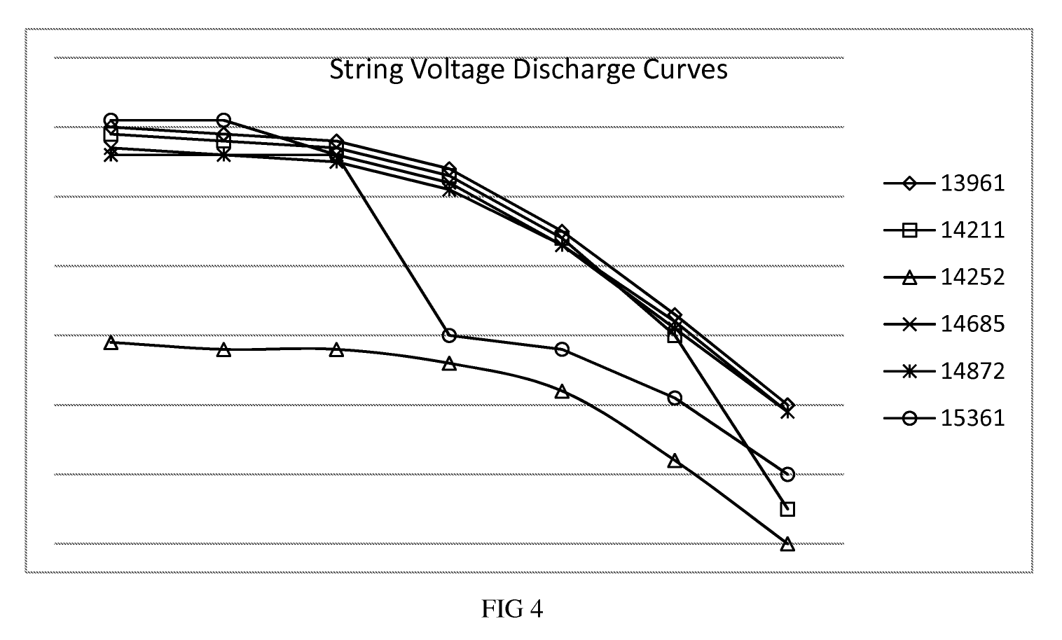

FIG. 4 illustrates a set of discharge curves from production sites, in accordance with embodiments of the present disclosure. Specifically, FIG. 4 illustrates the need for a RTP system which allows operations personnel to know how much battery backup time is remaining at a given location. Particular attention is brought to battery strings 14685, 14872, 15118, and 15361, where the voltage discharge is extremely unpredictable and dramatic. Depending on the application to which these back up battery strings are being applied, lack of accurate remaining runtime predictions could cause unexpected and catastrophic service disruptions.

The second step entails determining an unadjusted cutoff time and computing a compensation factor to apply to the unadjusted cutoff time when calculating the string-level remaining runtime estimate. At 318, embodiments of the disclosure may determine a remaining runtime for each battery string based on the discharge model. When determining a remaining runtime for each battery string, it is important to understand that the slope of the discharge line is based on the initial and current set of voltages where the average of the highest voltages as described above represents the voltage of the “y-intercept” and the intersection of the “x-reference line” represented by the cutoff voltage. The time from the current time to the projected time that the discharge will decrease to the cutoff voltage provides a starting point for the remaining runtime calculation. This time is the unadjusted cutoff time and may be found if there is a negative slope by applying Equation 1 below, where y is a battery cutoff threshold, m is an average battery voltage rate of change (i.e. slope), b is an initial average battery voltage (i.e. y-intercept), and τ_{uco} is the unadjusted cutoff time.

τ_{uco}=(y−b)/m Equation 1

Note that τ_{uco} is the total duration from the start of the standby event until the time the battery string reaches the cutoff voltage.

However, discharge curves for batteries are not linear like that used for the unadjusted cutoff time; therefore, a nonlinear adjustment must be made to the remaining runtime calculation. The adjusted cutoff time may be found by applying Equation 2 below, where τ is time from the start of the standby event, υ_{bco} is the battery cutoff voltage, τ_{aco} an adjusted cutoff time, α is a time scaling factor, β is a first voltage ratio multiplier, and δ is a second voltage ratio multiplier.

τ_{aco}=((τ_{uco}/(1+(1/e^{ατ})))−τ)*(υ_{bco}/β)^{δ} Equation 2

Note that the adjusted cutoff time is the time remaining from the current time until the time the battery string reaches the cutoff voltage.

The part of the equation, [τ_{uco}/(1+(1/e^{ατ}))], takes the total unadjusted time projected for the battery string to discharge and divides it by a non-linear factor that approximates the battery discharge curve. The time from the start of the standby event to the current time is subtracted from the adjusted time resulting in the time remaining [(τ_{uco}/(1+(1/e^{ατ})))−τ)]. In order to accommodate a range of cutoff voltages, the time is multiplied by [(υ_{bco}/β)^{δ}].

The two key aspects of the RTP system are the normalization of string voltages into an average battery voltage and the use of return codes. The normalization of the voltages during a standby event (i.e. under load) allows all calculations to be consistent throughout the system and is independent of the number of batteries in any given string. These algorithms calculate the average battery voltage in the string and the average battery voltage across a set of strings.

The string-level calculation returns one of the following return codes to be used in the site-level remaining runtime calculation. These same codes are used by the site-level remaining runtime calculation. The final results may then be translated into one of the Time Range Estimates for output for each set of standby event data provided to the RTP system. For example, if the RTP system received new standby data each minute, the RTP system will return a corresponding Time Range Estimate each minute.

At 320, embodiments may communicate a return code for each battery string and the entire site based on the corresponding remaining runtime and average string voltage. An example of these return codes and the corresponding Time Range Estimates, τ, in minutes is shown below in Table 1. The xxx in the return code is 10 times the string voltage and is used in the site-level remaining runtime calculation.

TABLE 1

| Time Range Estimate (minutes) | Return Codes |
|---|---|
| 0 <= T < 15 | xxx |
| 15 <= T < 60 | 1xxx |
| 60 <= T < 120 | 2xxx |
| T > 60 | 3900 (3xxx set to 3900) |
| 120 <= T < 180 | 4xxx |
| T > 120 | 5900 (5xxx set to 5900) |
| T > 180 | 6xxx |

Specifically, in cases 6 through 12, the following return codes may be returned based on the corresponding results from Test 4 (i.e. t4cutoffTime), described above. If the t4cutoffTime is less than 15 minutes and the t4cutoffTime is not equal to negative one (i.e. no estimate found) and t4cutoffTime is not equal to “estimateNotYetKnown,” then Case 6 may be set to “true” and the return code of xxx may be returned.

Yet, if the t4cutoffTime is greater than or equal to 15 minutes and the t4cutoffTime is less than 60 and the t4cutoffTime is not equal to −1 then Case 7 may be set to “true” and the return code of 1xxx may be returned. While, if the t4cutoffTime is greater than or equal to 60 minutes and the t4cutoffTime is less than 120 minutes and the t4cutoffTime is not equal to −1 then Case 8 may be set to “true” and the return code of 2xxx may be returned.

Still, if the t4cutoffTime is greater than or equal to 120 minutes and the t4cutoffTime is less than 180 and the t4cutoffTime is not equal to −1 then Case 9 may be set to “true” and the return code of 4xxx may be returned. Whereas, if the t4cutoffTime is greater than or equal to 180 minutes and the t4cutoffTime is not equal to −1 then Case 10 may be set to “true” and the return code of 6xxx may be returned.

However, if the t4cutoffTime is greater than 60 minutes and the t4cutoffTime is not equal to −1 or the t4cutoffTime equals “estimateNotYetKnown” then Case 11 may be set to “true” and the return code of 3000 may be returned indicating that the t4cutoffTime is equal to “estimateNotYetKnown.” Otherwise, Case 12 may be set to “true” and a code of −1 may be returned indicating a system problem.

Additionally, case 6 determines if the remaining runtime is unknown. Case 6 does not involve the use of a test, but instead, may evaluate the outcome of previous cases. If cases 1 through 4 are false and the standby event has been active for less than a minimum amount of time to collect adequate data (minROCWindow), then Case 5 provides a return code of 3900 and sets the variable representing case 5 to “true.” But if cases 1 through 4 are false and the standby event has been active for at least the minimum amount of time to collect adequate data (minROCWindow) or if any of the cases 1 through 4 are true, then Case 5 remains “false.” It is worth noting that all cases are initialized as “false.”

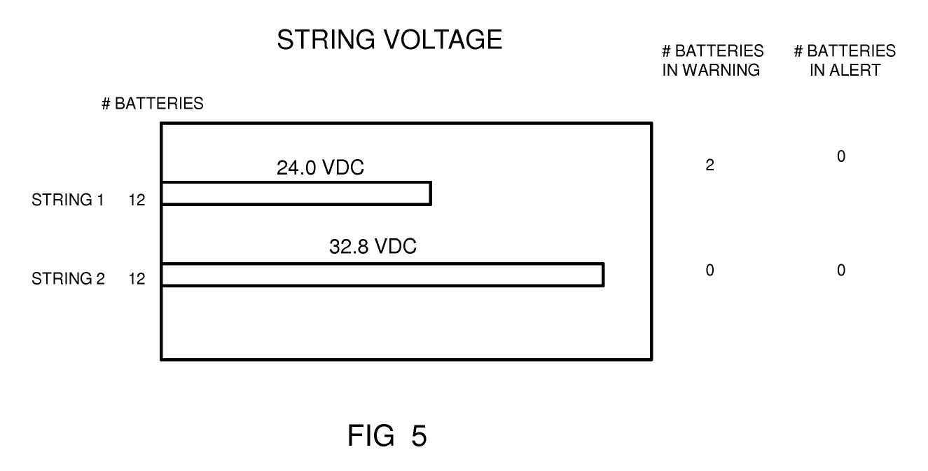

FIG. 5 illustrates possible display information which may be provided in conjunction with return codes. Specifically, FIG. 5 illustrates the limited information and detail, and therefore less precise (i.e., expensive) measurements, which are required by embodiments of the present disclosure. For example, string voltages being supplied to the RTP system need not be in hundredths or thousandths of volts. Instead, certain embodiments merely need measurements accurate to tenths of a volt. Consequently, embodiments of the disclosure may be employed in a wider variety of applications by clients both big and small.

After calculating the string-level remaining runtimes for one or more remote strings, these string level remaining runtime calculations may be used to calculate the a level remaining runtime. The site-level remaining runtime calculation provides the remaining runtime estimate for a complete site. The site can contain a single battery, a single string of batteries, or multiple strings of batteries. After a number, s, site-level estimates are calculated, the results may be passed through a smoothing algorithm for the final result.

A combination of algorithms may be used to determine the site-level results. For example, these algorithms may include a voting scheme, averaging, and a set of heuristic-based cases. Moreover, these cases, or rules, may take a form similar to those shown below. For example, if the estimate runtime, τ, is greater than 60 for more than a percentage, X₁, of the strings, then a code of 3499 (i.e. τ>60) may be returned as the site level estimate. While if the estimate runtime τ is greater than 180 for more than a percentage, X₁, of the strings, then a code of 6499 (i.e. τ>180) may be returned as the site level estimate. Additionally, if the estimate runtime τ is greater than 60 for less than a percentage, X₁, of the strings, then the strings that return a runtime greater than 60 may be removed from the vote. Similarly, if the average of the string-level results is in a lower percent, X₂, of the τ>60 range, then a code of 2499 (i.e. 60<=τ<120) may be returned as the site level estimate.

Finally, in certain instances if the average of the string-level results is in an upper percentage, X₃, of the τ>60 range, then a code of 4499 (i.e. 120<=τ<180) may be returned as the site level estimate. Otherwise the average remaining runtime across all of the string should be returned.

Additionally, the final step in a site-level remaining runtime calculation may include a smoothing of the results using a voting scheme. For example, the RTP system may take the most recent remaining runtime result and compare that against the previous number, minNumberOfResults, of remaining runtime results. In certain embodiments this value may be configurable.

The largest number of the same results must indicate a change in the estimate in order for the estimate reported to change. If there are fewer than the number, minNumberOfResults, calculated, as will be the case at the start of the standby event, then no change of the result will be reported.

Once the site-level remaining runtime is calculated, the local (e.g. minute-to-minute) variations in the estimate are “smoothed” by using a voting algorithm with the current site-level estimate with a configurable number of previous estimates.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims

While the foregoing is directed to embodiments of the present disclosure, other and further embodiments of the disclosure may be devised without departing from the basic scope thereof, and the scope thereof is determined by the claims that follow.

1. A method for sampling battery runtime-related information from one or more battery strings to provide an ongoing estimate of a remaining runtime left at a remote location, the method comprising:
receiving input data for each battery string of the one or more battery strings;
evaluating the input data and synthesizing one or more pieces of supplemental data;
filtering the input data and the one or more pieces of supplemental data;
storing the previously filtered data;
generating a discharge model based on the stored filtered data;
determining a remaining runtime for the one or more battery strings based on the discharge model; and
communicating a return code for the one or more battery strings based on the corresponding remaining runtime and average string voltage.

2. The method of claim 1, wherein filtering the input data comprises normalizing the voltage of at least one of the one or more battery strings.

3. The method of claim 1, wherein the input data does not include the voltage measurements of an individual battery of the one or more battery strings.

4. The method of claim 1, wherein determining a remaining runtime for the one or more battery strings comprises predicting an unadjusted cutoff time and a non-linear discharge correction element.

5. The method of claim 4, wherein predicting an unadjusted cutoff time is based, at least in part, on linear extrapolation.

6. The method of claim 4, wherein the non-linear discharge correction element is a decay function.

7. The method of claim 1 further comprising determining a remaining runtime for the entire remote location.

8. The method of claim 7 wherein determining a remaining runtime for the entire remote location comprises smoothing results using a combination of voting scheme, averaging, and case based heuristics.

9. An apparatus for sampling battery runtime-related information from one or more battery strings to provide an ongoing estimate of a remaining runtime left at a remote location, the apparatus comprising:
means for receiving input data for each battery string of the one or more battery strings;
means for evaluating the input data and synthesizing one or more pieces of supplemental data;
means for filtering the input data and the one or more pieces of supplemental data;
means for storing the previously filtered data;
means for generating a discharge model based on the stored filtered data;
means for determining a remaining runtime for the one or more battery strings based on the discharge model; and
means for communicating a return code for the one or more battery strings based on the corresponding remaining runtime and average string voltage.

10. The apparatus of claim 9, wherein the means for filtering the input data comprises normalizing the voltage of at least one of the one or more battery strings.

11. The apparatus of claim 9, wherein the input data does not include the voltage measurements of an individual battery of the one or more battery strings.

12. The apparatus of claim 9, wherein the means for determining a remaining runtime for the one or more battery strings comprises the means for predicting an unadjusted cutoff time and a non-linear discharge correction element.

13. The apparatus of claim 12, wherein the means for predicting an unadjusted cutoff time is configured to utilize, at least in part, linear extrapolation.

14. The apparatus of claim 12, wherein the means for a non-linear discharge correction element is configured to utilize a decay function.

15. The apparatus of claim 9 further comprising a means for determining a remaining runtime for the entire remote location.

16. The apparatus of claim 15 wherein the means for determining a remaining runtime for the entire remote location is configured to utilize a means for smoothing results using a combination of voting scheme, averaging, and case based heuristics.

17. A computer program product for sampling battery runtime-related information from one or more battery strings to provide an ongoing estimate of a remaining runtime left at a remote location, the computer program product comprising:
code for receiving input data for each battery string of the one or more battery strings;
code for evaluating the input data and synthesizing one or more pieces of supplemental data;
code for filtering the input data and the one or more pieces of supplemental data;
code for storing the previously filtered data;
code for generating a discharge model based on the stored filtered data;
code for determining a remaining runtime for the one or more battery strings based on the discharge model; and
code for communicating a return code for the one or more battery strings based on the corresponding remaining runtime and average string voltage.

18. The computer program product of claim 17, wherein code for filtering the input data comprises normalizing the voltage of at least one of the one or more battery strings.

19. The computer program product of claim 17, wherein the input data does not include the voltage measurements of an individual battery of the one or more battery strings.

20. The computer program product of claim 17, wherein code for determining a remaining runtime for the one or more battery strings comprises predicting an unadjusted cutoff time and a non-linear discharge correction element.

21. The computer program product of claim 20, wherein code for predicting an unadjusted cutoff time is based, at least in part, on linear extrapolation.

22. The computer program product of claim 20, wherein the non-linear discharge correction element is a decay function.

23. The computer program product of claim 17 further comprising code for determining a remaining runtime for the entire remote location.

24. The computer program product of claim 23 wherein code for determining a remaining runtime for the entire remote location comprises smoothing results using a combination of voting scheme, averaging, and case based heuristics.
